(19) United States
(12) Patent Application Publication
(10) Pub. No.: US 2025/0340114 A1
(43) Pub. Date: Nov. 6, 2025

(54) HYDRAULIC SYSTEM CONTROL ARCHITECTURE FOR A REFUSE VEHICLE

(71) Applicant: Oshkosh Corporation, Oshkosh, WI (US)

(72) Inventor: Vince Schad, Oshkosh, WI (US)

(73) Assignee: Oshkosh Corporation, Oshkosh, WI (US)

(21) Appl. No.: 19/197,734

(22) Filed: May 2, 2025

Related U.S. Application Data
(60) Provisional application No. 63/642,069, filed on May 3, 2024.

(51) Int. Cl. B60K 25/02; B60K 17/28; B65F 3/02

(52) U.S. Cl. CPC B60K 25/02; B60K 17/28; B65F 3/02; B60K 2025/026; B65F 2003/0283

(57) ABSTRACT

A refuse vehicle includes a chassis coupled to a plurality of motive members; an internal combustion engine coupled to the chassis and configured to power movement of the plurality of motive members; a vehicle body coupled to the chassis and defining a refuse compartment for storing refuse therein; a hydraulic actuator coupled to the vehicle body; and a hydraulic power take-off system. The hydraulic power take-off system includes a hydraulic pump fluidly coupled to the hydraulic actuator; a clutch operably coupled between the hydraulic pump and the internal combustion engine; and a controller communicably coupled to the clutch and configured to control the clutch to selectively couple the internal combustion engine to the hydraulic pump based on a function request to actuate the hydraulic actuator.

### CROSS-REFERENCE TO RELATED PATENT APPLICATIONS

This application claims the benefit of and priority to U.S. Provisional Application 63/642,069, filed May 3, 2024, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle including a chassis coupled to a plurality of motive members; an internal combustion engine coupled to the chassis and configured to power movement of the plurality of motive members; a vehicle body coupled to the chassis and defining a refuse compartment for storing refuse therein; a hydraulic actuator coupled to the vehicle body; and a hydraulic power take-off system. The hydraulic power take-off system includes a hydraulic pump fluidly coupled to the hydraulic actuator; a clutch operably coupled between the hydraulic pump and the internal combustion engine; and a controller communicably coupled to the clutch and configured to control the clutch to selectively couple the internal combustion engine to the hydraulic pump based on a function request to actuate the hydraulic actuator.

In some embodiments, the controller is communicably coupled to the hydraulic pump and is configured to control a displacement of the hydraulic pump based on the function request. In some embodiments, the controller is further configured to control operation of the clutch between a first mode in which the hydraulic pump is decoupled from the internal combustion engine and a second mode in which the hydraulic pump is rotationally coupled to the internal combustion engine and is powered by the internal combustion engine. In some embodiments, the controller is further configured to control operation of the clutch between the second mode in which the hydraulic pump is rotationally coupled to the internal combustion engine and is powered by the internal combustion engine and a third mode in which the hydraulic pump is operated to provide hydraulic fluid to the hydraulic actuator.

In some embodiments, the hydraulic power take-off system further includes a valve fluidly coupled to the hydraulic actuator that is configured to control a flow rate of hydraulic fluid to the hydraulic actuator. In some embodiments, the controller is further configured to control the valve, based on the function request, to adjust the flow rate of hydraulic fluid to the hydraulic actuator. In some embodiments, the hydraulic power take-off system further includes a valve and a sensor coupled to the hydraulic actuator. The controller is communicably coupled to the valve and the sensor, where the controller is further configured to receive sensor data from the sensor, and control operation of the valve to adjust a flow rate of hydraulic fluid to the hydraulic actuator based on the sensor data. In some embodiments, the controller is further configured to control operation of the valve to adjust the flow rate of hydraulic fluid to the hydraulic actuator based on a second function indicative of a desired flow rate of hydraulic fluid to the hydraulic actuator.

In some embodiments, the controller is further configured to determine the function request, where the function request is indicative of a predicted use of the hydraulic power take-off system in a near future time period. In some embodiments, the function request is determined using one or more of GPS data from a network, route-based data, and/or past performance data of the hydraulic power take-off system.

Another embodiment relates to a hydraulic power take-off system for a refuse vehicle. The hydraulic power take-off system includes a hydraulic pump configured to be fluidly coupled to a hydraulic actuator; a clutch configured to operably couple the hydraulic pump to an internal combustion engine of the refuse vehicle; and a controller communicably coupled to the clutch and configured to control the clutch to selectively couple the internal combustion engine to the hydraulic pump based on a function request to actuate the hydraulic actuator.

Another embodiment relates to a method for controlling a hydraulic power take-off system of a refuse vehicle. The method includes receiving a first function request to initiate operation of a hydraulic pump onboard the refuse vehicle. In some embodiments, the method further includes determining, based on the first function request, if a clutch of the hydraulic power take-off system should be engaged and if a hydraulic pump of the hydraulic power take-off system should be activated. The method further includes controlling, based on the first function request, the clutch to engage the clutch to mechanically couple an internal combustion engine of the refuse vehicle to the hydraulic pump. The method further includes receiving a second function request, where the second function request is indicative of desired use of the hydraulic actuator that is fluidly coupled to the hydraulic pump. The method further includes providing, based on the second function request, hydraulic fluid from the hydraulic pump to the hydraulic actuator.

In some embodiments, the method further includes controlling the hydraulic power take-off system into a first mode, where the clutch is disengaged, and the hydraulic pump is deactivated. In some embodiments, the method further includes controlling the hydraulic power take-off system into a second mode, based on the first function request, where the clutch is engaged, and the hydraulic pump is activated. In some embodiments, the method further includes controlling hydraulic power take-off system into a third mode, based on the second function request, where the hydraulic pump is operated.

In some embodiments, the method further includes determining, based on receiving the first function request and the clutch being engaged, a hydraulic pressure within the hydraulic power take-off system. In some embodiments, the method further includes adjusting, based on the hydraulic pressure being greater than or less than a desired hydraulic pressure, the hydraulic pressure of the hydraulic power-take off system until the hydraulic pressure reaches the desired hydraulic pressure. In some embodiments, the method further includes receiving a third function request indicative of a desired hydraulic pressure in the hydraulic power take-off system, and adjusting, based on the third function request, the hydraulic pressure of the hydraulic power-take off system until the hydraulic pressure reaches the desired hydraulic pressure.

In some embodiments, the method further includes determining the first function request, where the first function request is indicative of predicted use of the hydraulic power take-off system in a near future. In some embodiments, the first function request is determined using one or more of GPS data from a network, route-based data, and/or past performance data of the hydraulic power take-off system.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a block diagram of a hydraulic power take-off system for a refuse vehicle, according to an exemplary embodiment;

FIG. 3 is a block diagram of a vehicle that includes a hydraulic power take-off system, according to an exemplary embodiment; and

FIG. 4 is a flow diagram of a method of controlling a hydraulic power take-off system for a vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, systems and methods described herein relate to controlling operation of a hydraulic system for a refuse vehicle powered by an internal combustion engine. More specifically, embodiments described herein relate to a hydraulic power take-off system that is configured to selectively activate/deactivate a hydraulic system onboard the refuse vehicle based on at least one function request. The function request may include a request (e.g., a user input, a user command, etc.) from an operator of the refuse vehicle, such as to actuate at least one of a lift system to empty the contents of a refuse container into the refuse vehicle or to actuate an ejector system configured to compact and/or eject refuse from the refuse vehicle. The function request may also include vehicle operating conditions, such as the operating state of the refuse vehicle (e.g., whether the refuse vehicle is in transit between neighborhoods or between stops along a route, etc.), a location of the refuse vehicle, a location of the operator relative to the refuse vehicle, and/or other vehicle conditions.

In at least one embodiment, the hydraulic power take-off system includes a clutch and a controller that is configured to control the clutch to selectively couple the internal combustion engine to the hydraulic pump based on the function request(s). For example, the controller may be configured to control the clutch to selectively activate the hydraulic pump based on commands from the operator to actuate the lift system and/or to ready the hydraulic system for operation as the refuse vehicle approaches a neighborhood, residence, or a commercial building. Such an arrangement can improve fuel efficiency of the internal combustion engine by avoiding operation of the hydraulic pump at all times (even if over a relief), thereby removing all parasitic loads from the engine when the hydraulic system is not operating.

In some embodiments, the controller is also configured to control operation of the hydraulic pump (e.g., pump displacement, etc.) and/or a valve(s) within the hydraulic system based on the function request. For example, the controller may be configured to control the displacement of the hydraulic pump (e.g., via a swashplate of the hydraulic pump, etc.), or otherwise control a flow rate of hydraulic fluid through the hydraulic system based on the type of hydraulic circuit being actuated (e.g., the ejector vs. the lift system, etc.). Such an arrangement can enable adjustment of the hydraulic load on the fly and based on application requirements, and eliminates the need to run the hydraulic pump at full power for lower power tasks. In some embodiments, the hydraulic power take-off system further implements load-sense controls based on real-time operating conditions in the hydraulic system to adjust power required by the hydraulic system and to avoid exceeding the maximum power output of the internal combustion engine.

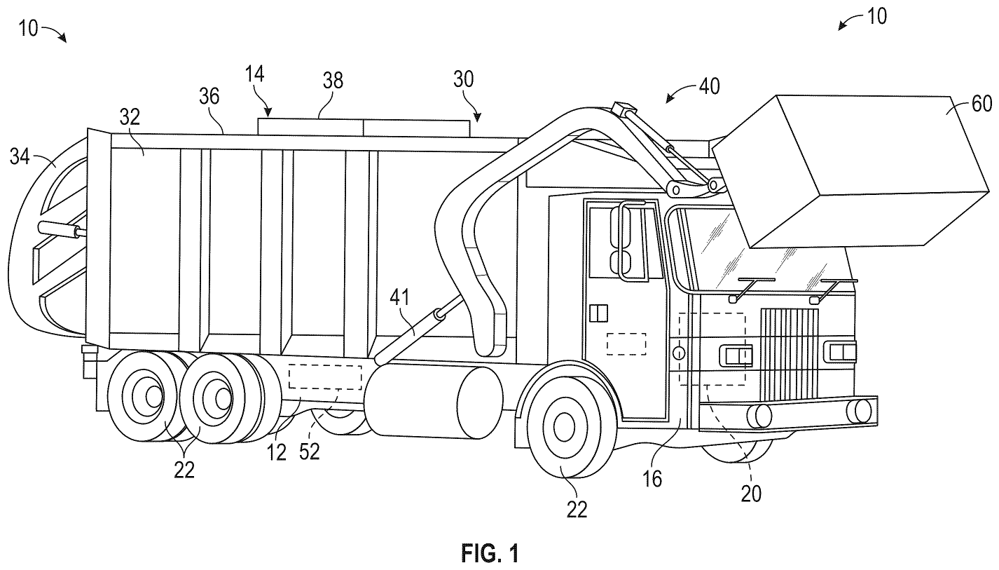

Referring to FIG. 1, a vocational vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the refuse vehicle (e.g., computers, controllers, processors, etc.). The refuse vehicle 10 further includes an internal combustion engine 20 coupled to the frame 12 at a position beneath the cab 16. The internal combustion engine 20 provides power to a plurality of motive members, shown as wheels 22, and to other systems of the vehicle (e.g., a pneumatic system, a hydraulic system, an electric system, etc.). A pair of wheels 22 may be coupled to an axle that is coupled to, and supported by, the frame 12. The refuse vehicle 10 may include at least two axles. In some embodiments, the refuse vehicle 10 may include at least four axles, and may include five axles in various embodiments herein.

The internal combustion engine 20 that is configured to generate power using one or more fuels. For example, the internal combustion engine 20 may be configured to use a variety of fuels (e.g., gasoline, diesel, biodiesel, ethanol, natural gas, etc.), according to various exemplary embodiments.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a refuse compartment 30 (e.g., a collection chamber, etc.). In some embodiments, the body 14 includes a plurality of panels, shown as panels 32, a tailgate 34, and a cover 36 that together define the refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14. In some embodiments, the body 14 further includes a tailgate actuator to selectively open the tailgate 34 and to facilitate removal of refuse materials stored in the refuse compartment 30.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include a hydraulic actuator, shown as lift actuator 41, to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

In some embodiments, the refuse vehicle 10 also includes other application-specific hydraulic actuator systems to control vehicle operations. For example, the refuse vehicle 10 may include an ejector system including an ejector (e.g., a packer, a compactor, etc.) and an ejector actuator that is configured to move the ejector to compact loose refuse material within the refuse compartment 30, and/or to eject the refuse material through the tailgate 34. In some embodiments, the refuse vehicle 10 also includes a cover actuator system to control movement of the top door 38 of the refuse vehicle 10. In some embodiments, the refuse vehicle 10 also includes a service lift actuator system to move (e.g., tilt, etc.) the body 14 relative to the frame 12. In some embodiments, at least one of the actuators is a hydraulic actuator including a hydraulic cylinder driven by hydraulic pressure from one or more hydraulic pumps onboard the vehicle, as will be further described. In other embodiments, the refuse vehicle 10 includes additional, fewer, and/or different actuator systems.

Although embodiments disclosed herein are described with reference to a refuse vehicle, it should be understood that the hydraulic power take-off systems and control methods of the present disclosure may also be used on other vocational vehicles including, but not limited to, cement trucks (e.g., mixer vehicles), dump trucks, and other on and off-highway vehicles having hydraulically actuated systems.

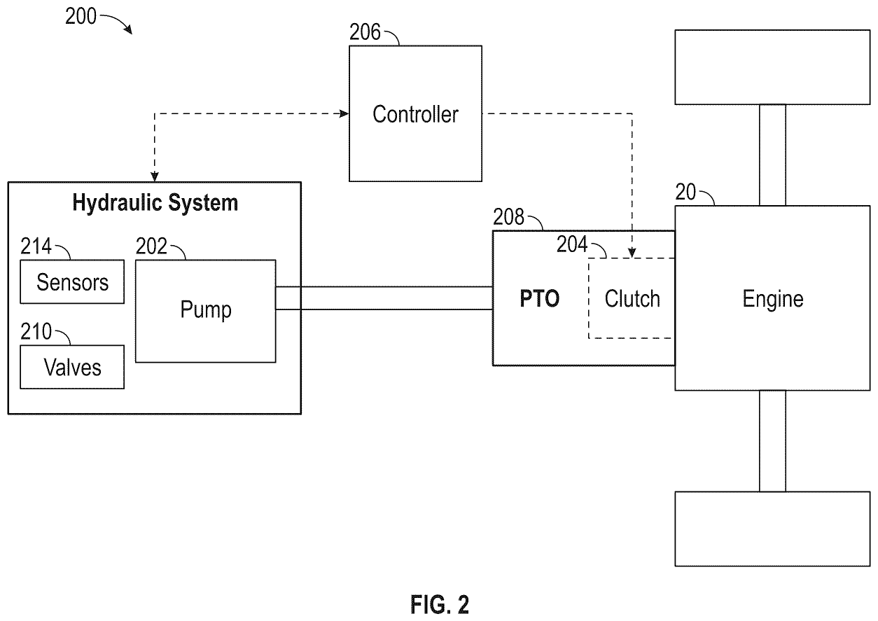

Referring to FIG. 2, the refuse vehicle 10 also includes a hydraulic power take-off system 200 that is configured to selectively control actuation of the hydraulic actuator systems (e.g., the hydraulic system, etc.) onboard the refuse vehicle 10, and the power provided to the hydraulic actuator systems from the internal combustion engine 20. The hydraulic power take-off system 200 is configured to control activation/deactivation and operation of the hydraulic actuator systems based on functions requests, as will be further described. In the embodiment of FIG. 2, the hydraulic power take-off system 200 includes a hydraulic pump 202, a clutch 204, and a controller 206. In other embodiments, the hydraulic power take-off system 200 may include additional, fewer, and/or different components.

The hydraulic pump 202 is configured to provide pressurized hydraulic fluid (e.g., oil, etc.) to a hydraulic system. Referring again to FIG. 1, the hydraulic pump 202 (see also FIG. 2) is fluidly coupled to at least one hydraulic actuator (e.g., the lift actuator 41 for the lift assembly 40, etc.) and is configured to provide pressurized hydraulic fluid to the lift assembly 40 (e.g., a lift actuator, etc.). In some embodiments, the hydraulic pump 202 may also be configured to provide pressurized hydraulic fluid to the ejector system, the cover actuator system, the tailgate actuator system, the service lift actuator system, and/or other hydraulic actuator systems. In some embodiments, the hydraulic pump 202 is one of a plurality of hydraulic pumps that are configured to be used individually or in combination with one another to power various portions of the hydraulic system onboard the refuse vehicle.

In some embodiments, the hydraulic pump 202 is a variable displacement pump that is adjustable to control an amount of hydraulic fluid being pumped through the system and/or the pressure of the hydraulic fluid. For example, the hydraulic pump 202 may be one of a variable displacement axial piston pump that uses a swashplate to vary the piston stroke and displacement, a variable displacement vane pump that is configured to adjust the eccentricity of a rotor of the hydraulic pump to change the displacement, or a variable displacement radial piston pump that includes a tilting swashplate or cam mechanism to adjust piston stroke and displacement of hydraulic fluid. Among other benefits, such an arrangement can enable control of the hydraulic pump 202 to vary hydraulic system pressure based on function requests, as will be further described.

Referring again to FIG. 2, the clutch 204 is operably coupled to the hydraulic pump 202 and the internal combustion engine 20 and is configured to rotatably couple the hydraulic pump 202 to the internal combustion engine 20. In some embodiments, the clutch 204 is a power take-off clutch that is configured to engage and disengage a power take-off shaft 208 to the internal combustion engine 20. When engaged, the clutch 204 prevents relative rotation between the power take-off shaft 208 and the internal combustion engine 20 so that the internal combustion engine 20 drives rotation of the power take-off shaft 208. In such embodiments, the hydraulic pump 202 may be directly mechanically coupled to the power take-off shaft 208. In some embodiments, the clutch 204 is a friction clutch having a friction disc (e.g., a clutch disc, etc.) configured to engage a flywheel to rotatably couple the internal combustion engine 20 to the power take-off shaft 208.

The controller 206 is communicably coupled to the clutch 204 and is configured to control the clutch 204 to selectively couple the internal combustion engine 20 to the hydraulic pump 202 based on a function request to actuate a hydraulic actuator. In some embodiments, the controller 206 is also communicably coupled to the hydraulic pump 202 and/or at least one valve associated with the hydraulic pump 202, and is configured to control operation of the hydraulic pump 202 and/or valve based on the function request to vary a flow rate of hydraulic fluid through the hydraulic system to satisfy the function request.

In some embodiments, the controller 206 is also configured to control operation of at least one valve, shown as valve 210, of the hydraulic system to prevent the internal combustion engine 20 from becoming overloaded, such as by adjusting the flow rate through different portions of the hydraulic system. For example, the controller 206 may be configured to receive sensor data from at least one sensor 214 that is fluidly coupled to the hydraulic system, and to control operation of the valve 210 to adjust a flow rate of hydraulic fluid to the hydraulic actuator based on the sensor data.

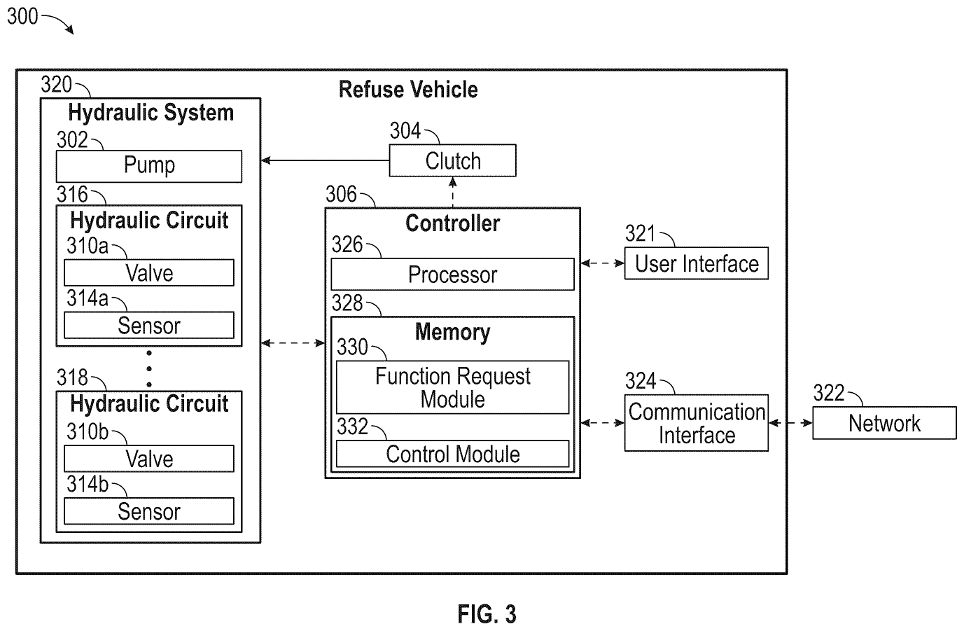

Referring to FIG. 3, a block diagram of a vehicle inclusive of a hydraulic power take-off system 300 is shown that is configured to control the flow of hydraulic fluid to multiple hydraulic circuits onboard the vehicle. The hydraulic circuits, shown as a first hydraulic circuit 316 and a second hydraulic circuit 318, are part of a hydraulic system 320 of the refuse vehicle that supports working operations of the refuse vehicle. The hydraulic power take-off system 300 also includes a hydraulic pump 302, a clutch 304, and a controller 306, which may be the same as or similar to the hydraulic pump 202, the clutch 204, and the controller 206 described with reference to FIG. 2.

The first hydraulic circuit 316 and the second hydraulic circuit 318 are configured to power individual hydraulic actuator systems onboard the refuse vehicle. In some embodiments, the first hydraulic circuit 316 is fluidly coupled to a first actuator and the second hydraulic circuit 318 is fluidly coupled to a second actuator that is different from the first actuator. For example, the first hydraulic circuit 316 may be fluidly coupled to a lift actuator of a lift assembly of the refuse vehicle, and the second hydraulic circuit 318 may be fluidly coupled to an ejector actuator of the ejector system. In other embodiments, the first hydraulic circuit 316 and the second hydraulic circuit 318 are different portions of a single hydraulic actuator system. In other embodiments the hydraulic system 320 includes additional hydraulic circuits.

In the embodiment of FIG. 2, each of the first hydraulic circuit 316 and the second hydraulic circuit 318 include at least one valve, shown as a first valve 310a and a second valve 310b, respectively, and at least one sensor, shown as a first sensor 314a and a second sensor 314b, respectively. In some embodiments, the valves are configured to control a flow of hydraulic fluid through the hydraulic actuators. The first valve 310a and the second valve 310b may be solenoid valves (e.g., pulse-width modulated valves, etc.) that are configured to control a flow rate of hydraulic flow into and out of at least one hydraulic actuator. In other embodiments, the first valve 310a and/or the second valve 310b is a load-sense valve that is configured to adjust the flow rate of hydraulic fluid through the hydraulic system based on a pressure of the hydraulic fluid at the hydraulic actuator. In some embodiments, the first sensor 314a and the second sensor 314b are pressure sensors that are configured to generate sensor data indicative of a pressure within at least a portion of the first hydraulic circuit 316 and the second hydraulic circuit 318, respectively, such as a hydraulic pressure at a respective one of the hydraulic actuators during operation.

In the embodiment of FIG. 2, the hydraulic pump 302 powers operation of each of the first hydraulic circuit 316 and the second hydraulic circuit 318. In other embodiments, the hydraulic system may include additional hydraulic pumps that are configured to provide pressurized hydraulic fluid to individual ones, or a combination of, the hydraulic circuits.

The controller 306 is communicably coupled to the hydraulic pump 302, the clutch 304, and the valves (e.g., the first valve 310a and/or the second valve 310b) and is configured to control the hydraulic pump 302, the clutch 304, and the valves to deliver pressurized hydraulic fluid to accommodate variable pump loads that may be requested during normal refuse vehicle operation. In some embodiments, the controller 306 is also communicably coupled to the first valve 310a and/or the second valve 310b and is configured to control the first valve 310a and/or the second valve 310b of the hydraulic circuits based on sensor data to prevent overloading the internal combustion engine.

In the embodiment of FIG. 3, the controller 306 is configured to control activation of the clutch 304 and flow rates provided by the hydraulic pump 302 based on a function request associated with one or more vehicle operating functions. As used herein, a “function request” refers to a request and/or command associated with the hydraulic system 320 onboard the refuse vehicle. In some embodiments, the “function request” refers to a request or command to actuate one or more hydraulic actuator systems of the refuse vehicle. For example, the function request may include a control signal indicative of at least one user input from the user/operator of the vehicle. In such instances, the controller 306 may be configured to receive the function request from a user interface 321. The function request may be indicative of a request to actuate one or more hydraulic systems onboard the vehicle, such as a request to operate a lift assembly, an ejector system, and/or another hydraulic subsystems that are powered by the hydraulic circuits.

In some embodiments, the function request includes or is indicative of an operating condition of the refuse vehicle. For example, the function request may be an electronic signal that is indicative of a location of the refuse vehicle relative to a work site (e.g., a residential area, a commercial business, a transfer site, etc.), such as a distance between the refuse vehicle and the work site, and/or an indication of whether the refuse vehicle has arrived at the work site or is in transit between worksites or stops along a refuse collection route. For example, the function request may correspond with global positioning sensor (GPS) data from a communications interface 324 indicating that the refuse vehicle has just entered a neighborhood for a refuse collection route. In some embodiments, the function request corresponds with other data transmitted to the refuse vehicle over a network 322 (e.g., the internet, a fleet management system, etc.), such as route-based data or past performance data of the refuse vehicle.

In some embodiments, the function request may correspond with one or more pressure levels (e.g., as indicated by sensor data from the first sensor 314a and/or the second sensor 314b, etc.) of the hydraulic system 320 exceeding or otherwise satisfying certain pressure thresholds. In other embodiments, the function request corresponds with a user location relative to the refuse vehicle, such as based on sensor data from a proximity sensor, a camera, or a wearable device. For example, the function request may correspond with sensor data from a camera that indicates that a user has approached a user interface for the hydraulic system 320 external to a cab of the refuse vehicle (which may indicate that the user intends to manually operate one or more hydraulic actuator systems of the refuse vehicle).

In some embodiments, the function request is configured to cause a power demand of the hydraulic system 320 to increase. For example, the function request may require an increase in hydraulic pressure for one or more of the hydraulic circuits within the hydraulic system 320, and/or activation of multiple hydraulic circuits simultaneously.

The controller 306 includes a processor 326 and a memory 328 storing machine-readable instructions thereon that, when read by the processor 326, causes the processor 326 to perform various operations to control the hydraulic power take-off system 300, as will be further described. In the embodiment of FIG. 3, the memory 328 (e.g., a cloud-based memory, an archive, a database, onboard memory, etc.) can supply a variety of different control parameters and information to execute different vehicle functions. In some embodiments, the memory 328 is communicably coupled (e.g., via the communications interface 324, etc.) to the network 322 and is configured to receive updated control algorithms and parameters from the network 322.

The memory 328 stores a plurality of modules, shown as a function request module 330 and a control module 332. In the embodiment of FIG. 3, the function request module 330 and the control module 332 are implemented as software modules. In other embodiments, the function request module 330 and the control module 332 are implemented as control circuits within the controller 306. The function request module 330 is configured to determine a function request based on user inputs. For example, the function request module 330 may be configured to determine an operating condition of the vehicle based on GPS data and/or an operator request based on user inputs (e.g., to the user interface 321), such as responsive to an operator selection of buttons, switches, and/or movement of one or more joysticks to control hydraulic system functions from within or outside of a cab of the refuse vehicle. For example, the function request module 330 may be configured to determine a desired rate of change of movement of at least one hydraulic actuator based on an amount of movement of a control joystick.

The control module 332 is configured to generate, based on the function request, a control signal and to transmit the control signal to the hydraulic pump 302 and/or the valves (e.g., the first valve 310a, the second valve 310b, etc.) to control operation of the hydraulic pump 302 and/or the valves. For example, the control module 332 may be configured to generate and transmit a control signal to the hydraulic pump 302 to vary a displacement of the hydraulic pump 302 based on the function request, and/or to the valves to vary a flow rate of hydraulic fluid into and out of the hydraulic actuators.

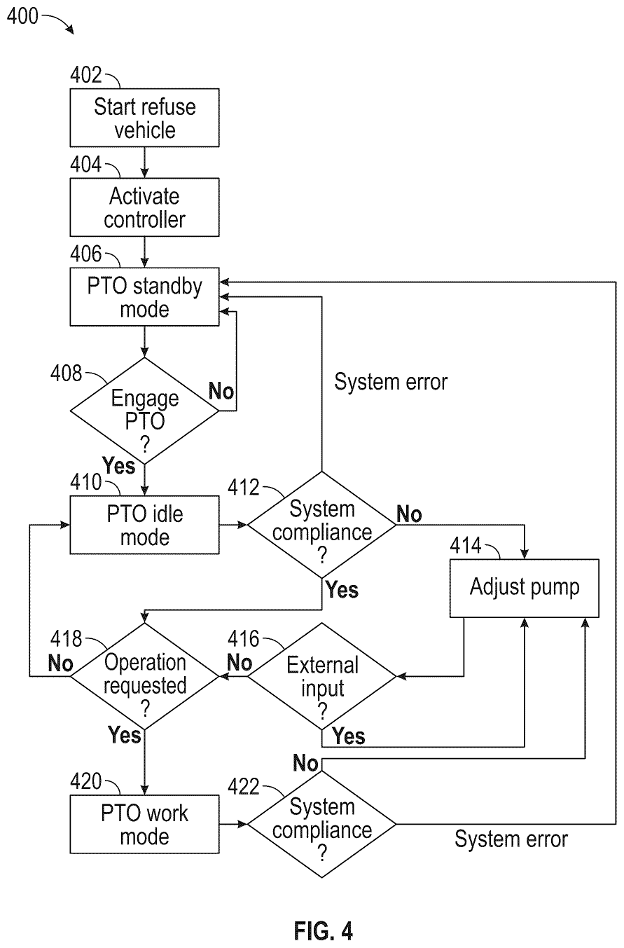

Referring to FIG. 4, a method 400 for controlling a hydraulic power take-off system is shown, according to an exemplary embodiment. The method 400 may be implemented with the controller 306 of hydraulic power take-off system 300 of FIG. 3 and thus will be described with reference to FIG. 3 and using the same terminology. In other embodiments, the method 400 may include additional, fewer, and/or different operations.

At 402, the refuse vehicle is started. For example, an operator of the refuse vehicle may cause the refuse vehicle to start, or the refuse vehicle may be started remotely. After the refuse vehicle is started, the controller (e.g., the controller 306) is activated as a part of operation 404. For example, the controller may be automatically activated upon starting of the vehicle. Once the controller is activated, the hydraulic power take-off system may enter standby mode as a part of operation 406. In standby mode, the clutch (e.g., the clutch 304, etc.) may be disengaged so that the hydraulic pump is completely shut off.

In some embodiments, operation 406 also includes receiving a first function request. The first function request may be a command signal, GPS data indicative of a vehicle location, or another signal to initiate operation of a hydraulic system onboard the refuse vehicle.

At 408, the controller determines if the clutch should be engaged to activate the hydraulic pump or remain disengaged. For example, the controller may determine that the hydraulic power take-off system will not be used in the near future. For example, the controller may utilize GPS data from a network, route-based data, and/or past performance data to determine that the hydraulic system is not needed until the refuse vehicle arrives to a certain location. If the controller determines that the clutch does not need to be engaged, the controller will cause the hydraulic power take-off system to remain in standby mode.

Alternatively, if the controller determines that the hydraulic system should be engaged, the controller may control the clutch to cause the hydraulic power take-off system to entire an idle mode. For example, if the controller determines that the hydraulic system may be needed in the near future, the controller may cause the hydraulic power take-off system to enter the idle mode. For example, the controller may utilize the GPS data, the route-based data, and/or past performance data to determine that the hydraulic system is or will be needed relatively soon, such as within a threshold time period, or based on an indication that the refuse vehicle has entered a neighborhood along a route. In other embodiments, the controller may receive an external input (e.g., an operator input on the user interface, sensor data from a camera monitoring an exterior user interface for the hydraulic system, actuation of the activation switch, etc.) and cause the hydraulic power take-off system to enter idle mode in response to the external input.

At 410, the controller causes the hydraulic power take-off system to enter idle mode. In idle mode, the hydraulic pump may be active. For example, the controller may generate and transmit a control signal to the clutch to engage the clutch and to initiate operation of the hydraulic pump. In some embodiments, operation 410 also includes transmitting a control signal to the hydraulic pump to reduce a displacement to a minimum level so as to reduce any parasitic losses as the system operates in idle mode.

At 412, the hydraulic power take-off system is checked for compliance. For example, the controller may be configured to receive pressure data (e.g., sensor data, etc.) from one or more of the sensors configured to measure hydraulic pressure within the hydraulic system (e.g., the first sensor 314a of FIG. 3, the second sensor 314b, of FIG. 3, etc.). If the fluid pressure is above or below a critical pressure, the controller may determine there is a system error, and the controller may cause the hydraulic power take-off system to return to standby mode. According to various embodiments, the hydraulic power take-off system may be configured to provide a baseline hydraulic pressure in idle mode that is less than in a work mode. According to various embodiments, the controller may increase the displacement of the hydraulic pump, and/or adjust the valves (e.g., the first valve 310a, the second valve 310b, etc.) until the desired hydraulic pressure is achieved as a part of operation 414. The method 400 may then proceed to operation 416. Alternatively, if the hydraulic pressure is already at the predetermined value, the method 400 may proceed from operation 412 to operation 418.

At 416, the controller receives or determines if there is a second function request. In some embodiments, operation 416 includes determining if there has been external input. For example, an operator of the refuse vehicle may request an increase or decrease in hydraulic pressure and/or flow rate using the user interface. If an external input is received or determined by the controller, the method 400 returns to operation 414, and the controller adjusts the hydraulic pressure accordingly (e.g., by adjusting the displacement of the hydraulic pump, and/or by closing off the valves that recirculate hydraulic fluid within the hydraulic system). If there is no external input received or determined, the method 400 proceeds to operation 418.

At 418, the controller receives or determines a third function request (e.g., a lift request, a compact request, an eject request, etc.). For example, an operator may input a function request to use a lifting mechanism, initiate a compactor operation, and/or to open the tailgate. If no function request is received or determined by the controller, the method 400 may return back to operation 410. However, if a third function request is received or determined by the controller, then the controller may cause the hydraulic power take-off system to enter work mode as a part of operation 420.

At 420, the controller causes the hydraulic power take-off system to enter a work mode. In the work mode, the hydraulic pump may be active and may be controlled to provide pressurized hydraulic fluid to one or more hydraulic actuators. In some embodiments, operation 420 includes controlling the valves to increase a flow rate of pressurized hydraulic fluid to the hydraulic actuator(s). In other embodiments, operation 420 includes adjusting a position of a swashplate for the hydraulic pump to control a displacement and flow rate provided by the hydraulic pump. For example, the controller may adjust a displacement of the hydraulic pump and/or hydraulic fluid from the hydraulic pump and through at least one hydraulic actuator to be greater than when the hydraulic power take-off system is in the idle mode. For example, in the work mode, the controller may control the displacement of the hydraulic pump to provide high enough fluid pressure and volume to perform the function requested at operation 418.

According to various embodiments, the controller may be configured check system compliance as a part of operation 422. For example, one or more of the sensors configured to measure hydraulic pressure within the hydraulic system may provide pressure data to the controller. If the fluid pressure is above or below a critical pressure, the controller may determine there is a system error, and the controller may cause the hydraulic power take-off system to return to standby mode. In other embodiments, the controller may be configured to adjust the load on the hydraulic system, such as by control one or more valves of the hydraulic to change the flow rate provided to at least one hydraulic actuator. Among other benefits, such operations can prevent overloading the internal combustion engine.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vocational vehicles as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis coupled to a plurality of motive members;
an internal combustion engine coupled to the chassis and configured to power movement of the plurality of motive members;
a vehicle body coupled to the chassis and defining a refuse compartment for storing refuse therein;
a hydraulic actuator coupled to the vehicle body; and
a hydraulic power take-off system comprising:
a hydraulic pump fluidly coupled to the hydraulic actuator; and
a clutch operably coupled between the hydraulic pump and the internal combustion engine; and
a controller communicably coupled to the clutch and configured to control the clutch to selectively couple the internal combustion engine to the hydraulic pump based on a function request to actuate the hydraulic actuator.

2. The refuse vehicle of claim 1, wherein the controller is communicably coupled to the hydraulic pump and is configured to control a displacement of the hydraulic pump based on the function request.

3. The refuse vehicle of claim 1, wherein the controller is further configured to control operation of the clutch between a first mode in which the hydraulic pump is decoupled from the internal combustion engine and a second mode in which the hydraulic pump is rotationally coupled to the internal combustion engine and is powered by the internal combustion engine.

4. The refuse vehicle of claim 3, wherein the controller is further configured to control operation of the clutch between the second mode in which the hydraulic pump is rotationally coupled to the internal combustion engine and is powered by the internal combustion engine and a third mode in which the hydraulic pump is operated to provide hydraulic fluid to the hydraulic actuator.

5. The refuse vehicle of claim 1, wherein the hydraulic power take-off system further comprises a valve fluidly coupled to the hydraulic actuator that is configured to control a flow rate of hydraulic fluid to the hydraulic actuator.

6. The refuse vehicle of claim 5, wherein the controller is further configured to control the valve, based on the function request, to adjust the flow rate of hydraulic fluid to the hydraulic actuator.

7. The refuse vehicle of claim 1, wherein the hydraulic power take-off system further comprises a valve and a sensor coupled to the hydraulic actuator, and wherein the controller is communicably coupled to the valve and the sensor, the controller further configured to:
receive sensor data from the sensor; and
control operation of the valve to adjust a flow rate of hydraulic fluid to the hydraulic actuator based on the sensor data.

8. The refuse vehicle of claim 7, wherein the controller is further configured to control operation of the valve to adjust the flow rate of hydraulic fluid to the hydraulic actuator based on a second function indicative of a desired flow rate of hydraulic fluid to the hydraulic actuator.

9. The refuse vehicle of claim 1, wherein the controller is further configured to determine the function request, wherein the function request is indicative of a predicted use of the hydraulic power take-off system in a near future time period.

10. The refuse vehicle of claim 9, wherein the function request is determined using one or more of GPS data from a network, route-based data, and/or past performance data of the hydraulic power take-off system.

11. A hydraulic power take-off system for a refuse vehicle, the hydraulic power take-off system comprising:
a hydraulic pump configured to be fluidly coupled to a hydraulic actuator;
a clutch configured to operably couple the hydraulic pump to an internal combustion engine of the refuse vehicle; and
a controller communicably coupled to the clutch and configured to control the clutch to selectively couple the internal combustion engine to the hydraulic pump based on a function request to actuate the hydraulic actuator.

12. The hydraulic power take-off system of claim 11, wherein the function request is indicative of an anticipated use of an accessory system of the refuse vehicle.

13. A method for controlling operation of a hydraulic pump onboard a refuse vehicle, the method comprising:
receiving a first function request to initiate operation of the hydraulic pump;
controlling, based on the first function request, a clutch to engage the clutch to mechanically couple an internal combustion engine of the refuse vehicle to the hydraulic pump;
receiving a second function request, where the second function request is indicative of desired use of a hydraulic actuator that is fluidly coupled to the hydraulic pump; and
providing, based on the second function request, hydraulic fluid from the hydraulic pump to the hydraulic actuator.

14. The method of claim 13, the method further comprising controlling the clutch to decouple the internal combustion engine to the hydraulic pump in an absence of the first function request.

15. The method of claim 13, wherein the first function request is indicative of a location of the refuse vehicle or a mode of operation of the refuse vehicle.

16. The method of claim 13, further comprising adjusting an operating condition of the hydraulic pump based on at least one of the first function request or the second function request.

17. The method of claim 13, the method further comprising determining, from sensor data received from a sensor coupled to the hydraulic pump, a hydraulic pressure.

18. The method of claim 17, the method further comprising determining a hydraulic pressure threshold based on at least one of the first function request or the second function request; and
adjusting, the hydraulic pressure generated by the hydraulic pump until the hydraulic pressure satisfies the hydraulic pressure threshold.

19. The method of claim 13, wherein the first function request is indicative of predicted use of the hydraulic actuator.

20. The method of claim 19, wherein the first function request is determined using one or more of GPS data from a network or route-based data.
